(19) United States
(12) Patent Application Publication
(10) Pub. No.: US 2002/0134322 A1
(43) Pub. Date: Sep. 26, 2002

(54) Gas fired appliance safety device

(76) Inventor: Pat Dolan, Seattle, WA (US)

Correspondence Address: Joseph Chalverus, Lake City Professional Center, 2611 N.E. 125th Street, Seattle, WA, 98125, US

(21) Appl. No.: 10/098,825

(22) Filed: Mar. 15, 2002

Related U.S. Application Data
(60) Provisional application No. 60/278,770, filed on Mar. 22, 2001.

(51) Int. Cl. F22B 37/42; F02M 59/20

(52) U.S. Cl. 122/504

(57) ABSTRACT

A flammable vapor detector is used to detect flammable vapors in the event of a volatile organic liquid spill near a gas fired appliance, such as a hot water heater. The appliance is mounted at an elevation above the floor while the detector is mounted at or near the floor where the spill may occur. The detector is connected electrically to a safety gas cut-off solenoid valve in the appliance to urge the valve to cut-off the flow of gas to the appliance in the event that the detector detects flammable vapor. Because the detector is below elevation of the appliance, the detector reacts to higher concentrations of flammable vapors than the concentrations of flammable vapors at the higher elevation of the appliance to turn off the gas to the appliance before the combustion air to the appliance reaches a lower flammability limit. The appliance used to describe the invention is a gas fired hot water heater.

### PRIOR PROVISIONAL PATENTS

The inventor claims benefit of the provisional co-pending patent application entitled WATER HEATER SAFETY DEVICE filed on Mar. 22,2001, 60/278770.

### I. BACKGROUND OF THE INVENTION

1. Field of the Invention

The invention relates generally to safety attachments and safety means for fuel fired, open flame appliances, such as furnaces and hot water heaters. More particularly, this invention relates to a safety device and means to shut-off fuel fed to an open flame appliance such as a hot water heater or furnace to prevent a catastrophic explosion in the event of a flammable substance spill nearby. This invention also relates to an improved means to monitor for flammable vapors in the air near an open flame gas fed appliance in order to shut off the gas fed to the appliance such as a furnace or hot water heater in the event that a dangerous level of flammable organic vapor is detected in the surrounding air.

2. Description of the Related Art

While many appliances use electricity as an energy source this invention relates to appliances that use vaporous gas as an energy source. Common gas fired appliances such as furnaces, and hot water heaters are commonly used in households and small commercial and business areas. For example, the common residential water heater is generally, an insulated, cylindrical tank of water oriented with the cylinder axis upright, placed at out-of-the-way places in the home, often garages, basements or storage areas of the residence of business to provide hot water on a demand basis. Hot water heaters are available in various standard sizes, and rated in terms capacity of gallons of water held by the appliance, and recovery rate. For the purposes of this invention, it may be understood that gas fired furnaces have many of the features of a hot water heater and have the same safety concerns.

In these appliances gaseous fuel, or gas is fed to a combustion chamber, such as to the base of the hot water heater to an area under a tank of water. Gaseous fuel include gases in the form of propane gas, natural gas or other flammable gases or liquids converted to gas, such as pressurized liquid petroleum, kerosine and gasoline vapors, etc. Air for combustion of the fuel is drawn from the surrounding air to the combustion chamber of the appliance. The size of the combustion chamber and type of fuel determines the recovery rate for the hot water heater or the heating capacity of the furnace. An open flame within a combustion chamber consumes gas to heat water within a tank for the hot water heater or to heat air for the furnace. Waste combustion gases rise by convection from the combustion chamber of the unit, such as through a center passage of the water tank, unless there is forced exhaust from the combustion chamber, such as for the power vent water heater.

For a hot water heater, a thermostat measures the temperature of the water within the tank. When the desired water temperature of the water is reached, the thermostat interrupts the gas flow from the source to the combustion chamber. A gas line feeds a pilot flame located proximal to the combustion chamber to be available to ignite the gas incoming to the combustion chamber, when needed. The flow of gas to the pilot flame is continuous unless the pilot flame becomes extinguished in which case the gas flow to the pilot as well as to the combustion chamber is interrupted by a valve in the gas line. The valve is spring held to a closed on no-flow operation, but is set open by a thermocouple current produced by a thermocouple within the pilot flame. In normal operation, the thermocouple produces a sufficient current to maintain the valve in an open or flow position. Should the flame extinguish, the current decreases below the holding force permitting the spring to force the valve into a closed or no-flow position, turning off all gas into the heater. The operation must then hand-start the heater by re-setting the valve and lighting the pilot until the holding current is reestablished.

As water is consumed from the tank, the temperature of the water falls to a determined minimum temperature at which time the in-tank thermostat opens the gas flow to the combustion chamber. The fuel is ignited by the pilot flame and the heating process resumes.

Some furnaces and some gas fired hot water heaters, such as the power vent use a hot ignition surface to replace the pilot light and pilot flame detector system.

Hot water heaters are often installed in out-of-the-way places, away from the living areas of the residential unit. The gas fired residential water heaters are often placed in storage areas or at the back or side areas of automobile garages, connected to water and gas lines, leading to and from the appliance. A potential problem arises from the fact that these areas are also used to store gasoline, paints and common flammable house hold solvents. For example, it is common for a hot water heater to be located within a garage near containers of gasoline used for small gasoline powered appliances such as lawn mowers, trimmers and the like. Likewise, organic solvent based paint and cleaning solutions are also highly flammable in the vapor form and often stored nearby the water heater. Should a gasoline container or flammable liquid container fall and break in the storage area, there may be a sudden release of highly flammable vapors released into the area near the hot water heater, or a nearby gas fired furnace. Some of the flammable vapors from the spilled material may be drawn into the combustion chamber of the water heater or furnace and be ignited by the pilot flame or the flame within the combustion chamber. In this case, combustion of the vapors will flash from the combustion chamber back towards the source of the spilled vapors caused by the spilled material outside the combustion chamber. This occurrence can produce an uncontrolled conflagration endangering lives and property and is called “backflash.”These events are not too uncommon. In 1990, the United States Consumer Product Safety Commission reports nearly 2,000 fires caused by water heaters igniting flammable vapors in the vicinity of a water heater resulting in damages to residence the United States alone.

As can be appreciated, air becomes flammable when the ratio of flammable vapor to air reaches or exceeds a lower flammability limit (“LFL”). Once gasoline or other flammable liquid spills onto a floor, the liquid expands over the surface of the floor and evaporates into the surrounding air as vapor. Because gasoline and most other volatile organic vapor is heaver than air, the concentration of vapor produced by the liquid evaporating on the floor will be at its greatest, decreasing with elevation above a spill on the floor. With time, however the concentration of vapor in the air will increase along the column of air above the spill as more vapor is diffused and mixed along the air column, until the liquid is evaporated. That is to say, once the spill of gasoline or other flammable organic solvent occurs, the percent of vapor in the air above the spill decreases with elevation and with time, the concentration of vapor above the spill at all heights will increase. For example, gasoline has a LFL of approximately 1.8 percent (%) by weight. If air with this mixture is entrained into the combustion chamber of a common appliance, a backflash will most likely occur. If the spill is small enough, the incoming air-vapor mixture at the combustion chamber of the appliance may never reach the combustion point and this strategy would be sufficient to avoid conflagration. If the appliance such as a hot water heater is elevated above the floor, then the air-vapor mixture at the elevated height may not reach the combustion point as well. Many building codes in the United State now require hot water heaters be installed a distance above the floor, typically 18 inches to take advantage of the lower vapor distribution along the column above a spill.

Other means to reduce the problem of backflash appliances such as the hot water heater have been to use a fine mesh screen known as a flame arrester screen to cover the air intakes of the water heater. If the mesh is sufficiently fine, the mesh will prevent a flame from flowing backwards through the mesh and back along incoming air flow from the combustion chamber. An example of this solution is described in U.S. Pat. No. 5,941,200 to Boros et al., U.S. Pat. No. 5,797,355 to Bourke et al and U.S. Pat. No. 6,109,216 to Reynolds et al. While a fine mesh does offer flame suppression to prevent back flame conflagration, the lower side of the fine mesh screen, with time will become clogged with dust and lint and other material to decrease the efficiency of the water heater. The fine mesh must be cleaned at regular intervals to maintain performance of the water heater. Scale and debris from the combustion chamber and exhaust flue may also fall on the top surface of the screen causing it to become clogged. The need to regularly clean the fire suppression screen is not widely known by the consuming public.

Other ways to address the problem of backflash have been to provide an outside combustion air source for the water heater, sometimes in combination with the exhaust flue gases, such as described in U.S. Pat. No. 4,940,042 to Moore, Jr. et al. or powered as described in U.S. Pat. No. 5,697,330 to Yetman et al. Because additional duct-work is needed for this solution, the water heater must be located near an outside wall, which is not often possible or convenient. Yet another attempt to solve the problem of backflash for hot water heaters is to install a bottom metal skirt or collar around the bottom of the take to raise the source of the combustion air source above the lower part of the water heater as described in U.S. Pat. No. 5,918,591 to Vollmar et al or with an air in-take vertical manifold to withdraw air from an elevation above the floor, as described in U.S. Pat. No. 6,058,892 to Haack, II.

Another means to prevent backflash of combustion for hot water heaters is to use is to use cylindrical air barrier or skirt to completely surround the bottom of the water heater to require the combustion air source entrained into the heater be from at least the height of the air barrier. The cylindrical air barrier is useful for after-installation use since the hot water heater does not have to be disconnected from the water and gas systems to be surrounded by the air barrier. As can be appreciated, a hot water heater consumes ambient air at a high rate, often sufficient to draw the denser combustible vapors a considerable distance, even to an elevated height or above the skirt.

Additionally, industry testing has demonstrated large spills of flammable liquid given time, may permit a flammable concentration of gasoline in the air to rise even a considerable distance above the floor. This can happen in the event that the spill is undetected and the gasoline or solvent has time to evaporate within a confined garage or storage area where little or no outside mixing occurs to defuse the vapors. These strategies only delay the flammable vapors reaching the combustion chamber or pilot light; to give time to personal to notice the spill, effect an escape, address the gasoline or solvent spill or to manually turn off the gas.

On going efforts are still being made to improve the safety of the open flame appliance such as the hot water heater. Such efforts have been addressed both to the general object of directing or interrupting air flow to the combustion chamber and pilot light, improving the performance of flame retarders as well as to the more specific object of improving the performance of the open flame water heater.

The purpose therefor of this invention is to provide a simple way to minimize the occurrence of a conflagration in circumstances of flammable vapors from spilled gasoline, or solvents onto the floor near an open flame, gas fed hot appliance such as a furnace or water heater and to address the problem directly: to use a flammable vapor detector in conjunction with the pilot light safety turn-off mechanism or gas feed shut-off system and, importantly, by locating the vapor detector below the combustion air intake of the appliance such as at or near the floor to take advantage of the higher concentration of the flammable vapors that occur on the floor than above. In this way, the detector will be able to react to the flammable vapor before the combustion air reaches the lower flammability limit (LFL) caused by the spill.

### II. BRIEF SUMMARY OF THE INVENTION

My invention incorporates the use of a fast-acting flammable vapor detector (“FVD”) in combination with an gas fired appliance such as a hot water heater or furnace to react and signal the safety shut off means to a pilot flame and combustion gas of the appliance. My invention includes mounting the FVD at an elevation below the combustion air for the appliance such as near or on the floor while the appliance or its combustion air intake is raised from the floor. This is because the highest concentrations of vapor from a spill is located at the floor. it will be appreciated that the detector should detect the vapor before any flammable vapors are entrained as combustion air into the appliance so by placing the detector at the floor, the detector has the greatest chance to react to the vapor before flammable vapors rise to the level of the air intake of the gas fired appliance.

There are various was for the FVD to be positioning at an elevation below the combustion air-intake of the appliance as will be described below.

My invention also details how the FVD may be used with the common house hold gas fired appliance such as the typical hot water heater with pilot light having a pilot light safety circuit. A pilot light safety circuit shuts off the gas to the appliance to both a pilot light and gas to the combustion chamber in the event that the pilot light becomes extinguished. The pilot light safety circuit uses a thermocouple junction physically located at or near the tip of the pilot light so the it is heated by the pilot light to produce a electric holding current. The holding current from the thermocouple junction is fed to a spring loaded solenoid operating a shut-off valve in line with the gas source. The gas source remains open as long as the holding current is above a preset level for the valve to remain in a flow position. Should the pilot flame extinguish, the current from the thermocouple rapidly decreases below the present level, triggering the solenoid to close the valve to interrupt the gas source to the hot water heater, to both the combustion chamber as well as the pilot flame. This is the no-flow or safety off position. In order to reestablish the flow, an operator must manually re-set the valve to a flow position while heating the thermocouple until the holding current is established.

A FVD has the properties of rapidly increasing its electrical resistance in the presence of flammable vapors such as volatile organic vapors, gasoline, paint thinners and various common household solvents. The FVD in the circuit with the thermocouple will decrease the current to the solenoid in the event of presence of flammable vapor thereby triggering the solenoid to shut off the gas source to the hot water heater in the same fashion as when the pilot flame thermocouple junction current decreases below the present level.

Flammable vapors are produced by the evaporation of the spilled organic volatile liquids. The vapor concentration is highest at the surface of the spill and decreases in concentration above the spill. With time, the spill evaporates causing the vapor concentration levels to increase at all elevations above the spill as time, flammable vapor from a spill rises in the column above the spill due to mixture and diffusion of the vapor with the air.

Because my invention also places the FVD at an elevation below the combustion source of air entrained into the combustion chamber, it takes advantage of the higher concentration of flammable vapor at lower elevations. With the FVD located at the floor it will measure to the highest concentration of flammable vapors in the event of a spill. This will enable the FVD to detect and control the safety shut-off valve for gas fed to the appliance much faster than anywhere else. By placing the appliance above the floor and the FVD at or near the floor, the FVD will be able to detect and turn off the flow of gas to the appliance before the combustion air reaches the LFL limit due to a spill.

Without gas flow, the flames within the appliance such as a hot water heater extinguish, removing the possibility of backflash from either the pilot light or the chamber. The gas source to the appliance will remain shut-off until an operator removes the source of flammable vapors and resets the pilot light safety solenoid and relights the pilot flame to reestablish the safety circuit for a hot water heater.

Accordingly, it is a general object of the present invention to provide an improved gas fired appliance safety device and means to prevent unwanted ignition of flammable vapors by the open flames within a gas fired appliance.

More specifically, it is an object of the present invention to detect flammable vapors in the air and to interrupt or shut off the gas to the hot water heater whenever flammable vapor is detected before the higher concentration of vapors are entrained into the gas fired appliance.

Even more particularly, it is an object of my invention to place a flammable vapor detector at a lower elevation, such as at floor level while raising the combustion source of air entrained into a gas fired appliance such as water heater or furnace and provide a means for the FVD to interrupt the fuel fed into the combustion chamber and pilot light of the appliance, such as using the pilot light safety shut-off circuit already available to many gas hot water heaters and furnaces.

Further objects and advantages of my invention will become apparent from a consideration of the drawings and ensuing description thereof.

### III. BRIEF DESCRIPTION OF THE DRAWING

FIG. 1 is a perspective of a hot water tank in an elevated position above the floor with a FVD at floor level.

FIG. 2 a side elevation view of the cross section of the hot water heater with FVD at floor level.

FIG. 3 a perspective of a hot water tank with a collar surrounding the base and FVD.

FIG. 4 a perspective of the a hot water tank on the floor with an elevated combustion air-intake vertical manifold and FVD near the base of the tank.

### IV. DESCRIPTION OF THE PREFERRED EMBODIMENT

There are many gas fired heating appliances which can use my invention, such as the common residential hot water heater used in homes and small commercial establishments, power vent water heaters, gas fired heating furnaces and the like. All these appliances have the potential to cause backflashing to spilled flammable liquids nearby as flammable vapors become entrained into the pilot light or combustion chamber during operation. The following preferred embodiment exemplifies implementation of the use of a FVD in combination with a gas fired appliance and positioning the FVD at an elevation below the elevation of combustion air to the appliance. The different elevations can be accomplished by simple raising the appliance from the floor or changing the source of combustion air from the floor while placing the FVD at or near the floor. This configuration will take advantage of the higher concentrations of vapors at the floor level and permit the FVD to reach and signal the safety gas-turn-off features of the appliance before the raised combustion air reaches the lower flammability limit.

It should also be understood that the FVD is a passive resistance element that greatly increases its electrical resistance in the presence of flammable vapor of many kinds, such as the volatile organic vapor in gasoline, paint thinners and common household solvents. This feature enables the FVD to be used advantantagiously in a variety of gas fired appliances since the appliances are already designed and built with safety gas shut off features. For example and as illustrated in detail below, some hot water heaters use continuously burning pilot flames to reignite burners within the combustion chamber upon demand for more heat. Should the pilot light become extinguished, these heaters use a means to cut off the gas to the appliance in this event. This system employs a thermocouple pilot flame detector. The thermocouple produces a current to urge a cut off valve open against an urging force. As long as the thermocouple produces a current above a threshold, the valve will remain open. The FVD can be placed in series with the pilot flame detector thermocouple so that its resistance decreases the current below threshold to trigger the cut off valve to close. Likewise, the FVD can be used just as effectively for appliances without pilot flames or flame detectors, such as those with ignition devices to prevent the flow of gas and to inhibit the sparking. While this particular embodiment describes a passive air flow gas heater with a pilot flame, my invention can be equally employed for a power vented water heater, with or without pilot flames and detectors since my invention employs the advantages of the FVD placed near the floor while the appliance is elevated from the floor so that the FVD can inhibit the flow of gas to the appliance before the vapors become entrained into as combustion air into the appliance.

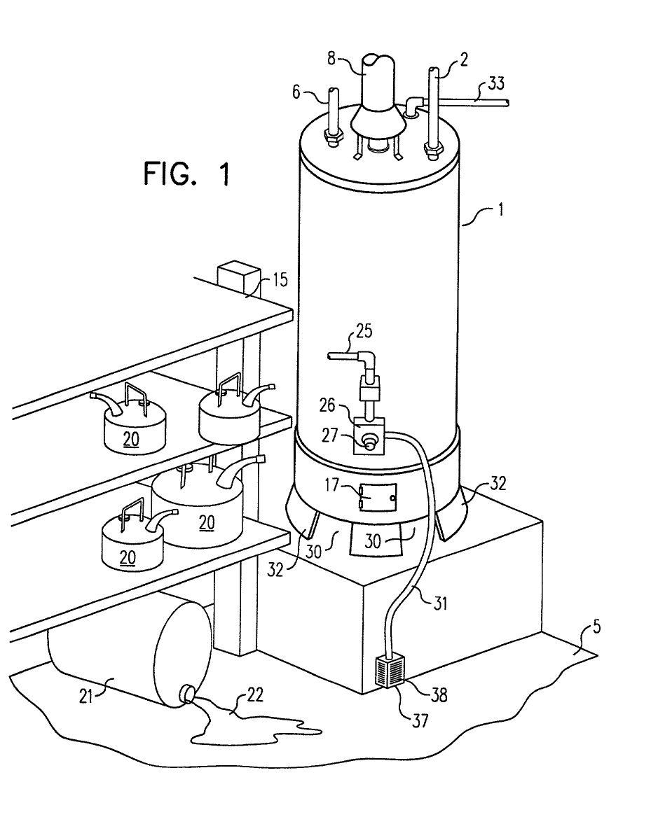

In this present example, a gas fired hot water heater, such as a residential water heater generally designated as 1 in FIG. 1 typifies the problem. The heater 1 is often installed near a corner or along the side of a wall in a closed garage or confined storage area of a residential or small commercial building. As illustrated by FIG. 1, the hot water heater 1 is installed elevated above the floor 5 located near shelves 15 storing canisters of solvents, house cleaning solvents, flammable paints, paint thinners, gasoline and kerosine, etc shown generally as 20. A canister 21 is shown on its side with a liquid 22 spilled on the floor 5.

As can be appreciated, invisible flammable vapors from the spill 22 mix and defuse with the air above the floor. If this canister 21 were gasoline, then gasoline from the spill 22 will evaporate into the air at the floor 5 above the spill 22 to form a dangerous and explosive mixture of flammable vapor with air. Because volatile organic vapors are heavier than air, there will be a gradient of vapor to air along the air column above the spill on the floor, starting from the highest (near saturation) at the surface of the spill 22.

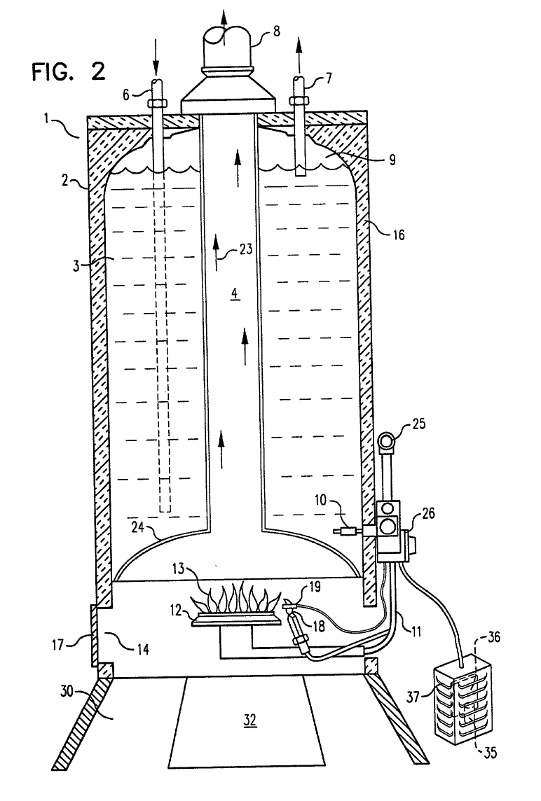

For use in a hot water heater, FIG. 2 illustrates a cross section of a typical upright water heater 1. The configuration of the interior pressurized hot water container or tank 3 is generally a vertically oriented toroidal cylinder, with the vertical center passage 4 used to conduct exhaust gases from the combustion chamber 12 to the outside by way of exhaust duct-work 8. Heated exhaust gases rise as shown by arrows through the passage 4 by normal convection of the heated gases from the combustion chamber through the duct-work 8 to the outside. Some gas fired hot water heaters use powered exhaust system (not shown) whereby exhaust gases from the combustion chamber are pulled by an exhaust fan (not shown) within an exhaust duct-work 8.

The heater provides on a demand basis, hot water for its users within the residence or for its business needs, nearby. For gas fired water heaters, 1 a fuel line 25 communicates to a control unit 26 having internally, a solenoid to turn off all gas in the event that the pilot flame extinguishes. The outer shell 2 of a typical hot water heater 1 is a painted sheet-metal cylinder surrounding an upright, toroidal, pressurized container or hot water tank 3; that is the inner tank is in the shape of cylinder with a longitudinal void 4 along its central axis.

Gas is fed to the water heater from line 25 from an area-wide distribution gas line or storage tank (not shown) according to the design of the water heater. The kind of gas commonly used for these heaters include natural gas, propane, coal gas and the like. The gas flows through control unit 26 having an water temperature control knob 27 on the outside of unit 26, to adjust the working temperature of the hot water within the heater.

The heater receives cold water from an pressurized intake water source 6 communicating to near the bottom portion of the interior of the tank 3 at the same internal pressure. Heated water 7 at the same pressure is removed from the heater according to water demand, from near the top of the level of water inside the water tank. When a hot water tap in the hot water system (not shown) is opened and supply pressure of the water system enables hot water to flow from the interior of the hot water tank, through the hot water distribution system, to the opened hot water tap. Cold water from the intake water source 6 replaces the loss within the hot water tank 20. A air pocket 9 above the water within the tank provides for a pressurized cushion of air to protect the tank from rupture due to momentary pressure spikes that may occur within the pipe system.

A thermostat 10 monitors the temperature of the water within the tank 3 to communicate temperature information to a control unit 26. When the water temperature at the thermostat 10 decreases below a preset working temperature, fuel flows though combustion supply line 11 to combustion chamber 12 located proximal and below the tank 3 where combustion of fuel occurs. When a preset working temperature is reached, the fuel is interrupted.

The fuel is ignited by the pilot flame 18 having a pilot flame sensor thermocouple 19 within the pilot flame to advise the control unit 26 should the flame be extinguished. In this event, the control unit 26 cuts-off the flow of gas into the hot water heater with an internal, spring loaded solenoid and control circuit valve; that is the solenoid sets the valve into a no-flow position. The gas flow remains shut-off or in a no-flow position until an operator reestablishes the control to a flow position, by resetting the solenoid controlled valve into a flow position and reigniting the pilot flame 18 for the length of time needed for the thermocouple to generate a current sufficient to resist triggering the spring loaded solenoid and remain in a flow condition. This system is well known in the art.

As the fuel burns within the chamber its by-products exhausts, combustion source of air is entrained into the combustion chamber through bottom vents 30 to replace the spent air.

The exhaust gases 23 are directed upwards from the chamber 12 to the bottom of the tank 24 to heat the water within the tank 3 and to pass through the void 4, also heating the tank 3 along the surface of the void 4. As the water within the tank 3 is heated, the water near the bottom of the tank circulates towards the top of the tank while the cooler water near the top of the tank 3 replaces the rising hot water.

An insulation layer 16 surrounds the hot water pressurized tank 3 within the outer shell 2 to reduce heat loss.

Access port 14 to the combustion chamber 12 with door 17 provides for closable access to the combustion chamber for service and repair.

For my invention, a fast acting, flammable vapor detector FVD 35 is mounted within a protective casing 37 with louvered vents 38. The louvered vents 38 in the casing 37 permit the exchange of air from the surroundings to the vapor detector 35. The vapor detector 35 passively measures volatile organic vapors such as methane, acetylene, ethane, propane, gasoline vapors. The detector employs a simple material having an electrical resistance between two contacts interconnected with vapor detector material that varies according to the amount of vapor adsorbed by the detector material at any one moment. A suitable vapor detector may be acquired from Adsistor Technology Inc., P.O. Box 51160, Seattle, Wash. 98115, USA. The FVD 35 is typically used as part of a current bridge, where one leg of the bridge is adjustable to a null according to the particular detector incorporated. The electrical resistivity of the FVD 35 rapidly increases in response to flammable vapors. By placing the FVD electrically in series with the pilot flame thermocouple sensor current within the control box 26, the thermocouple current is significantly attenuated when the FVD reacts in the presence of flammable vapor, triggering a signal to actuate the solenoid within the control unit 26 into a no-flow position, to turn off the gas in line 25 within control unit 26. In other words, the FVD decreases the thermocouple current by a variance of its electrical resistance, signaling or causing the solenoid to urge the valve to a no-flow position thereby interrupting the flow of gas to the entire hot-water heater 1.

Details regarding the operation and controls of a vapor detector are fully described in U.S. Pat. Nos. 3,045,198 Detection Device and in 4,129,030 Sensing Apparatus and Method, both to Dolan and are incorporated herein by reference.

As explained above, my invention also takes advantage of the properties that gasoline and other volatile organic vapor is denser than air, so that the highest density vapors will first lie at the floor above the spill, the with time, mix and defuse with the air above and surrounding air around the spill. Therefore, by placing the FVD at or near the floor or at an elevation below the combustion source of air, such as here intake 30 of a hot water heater, the FVD 35 detects flammable vapor before the dangerous vapors rise to be entrained into the combustion chamber 12, the FVD generating the signal to turn off the flow of gas before any flammable vapor is entrained into the water heater or gas fed appliance.

As shown in FIG. 1, a fuel fed hot water heater is installed at an elevation above the floor, typically 18 inches according to many code requirements while the FVD within its casing 36 is placed at a lower elevation, under or below the hot water heater at or near the floor 5. The hot water heater combustion source of air intakes vents 30 admit air into the combustion chamber 12 from this height. The FVD 35 passively detects flammable vapor and responds by altering its conductivity, decreasing the holding current of the solenoid internal to the control unit 26. In this manner, a gasoline or similarly dangerous spill of flammable solvents nearby causes the FVD to react before the flammable vapors at an LFL reach a higher elevation.

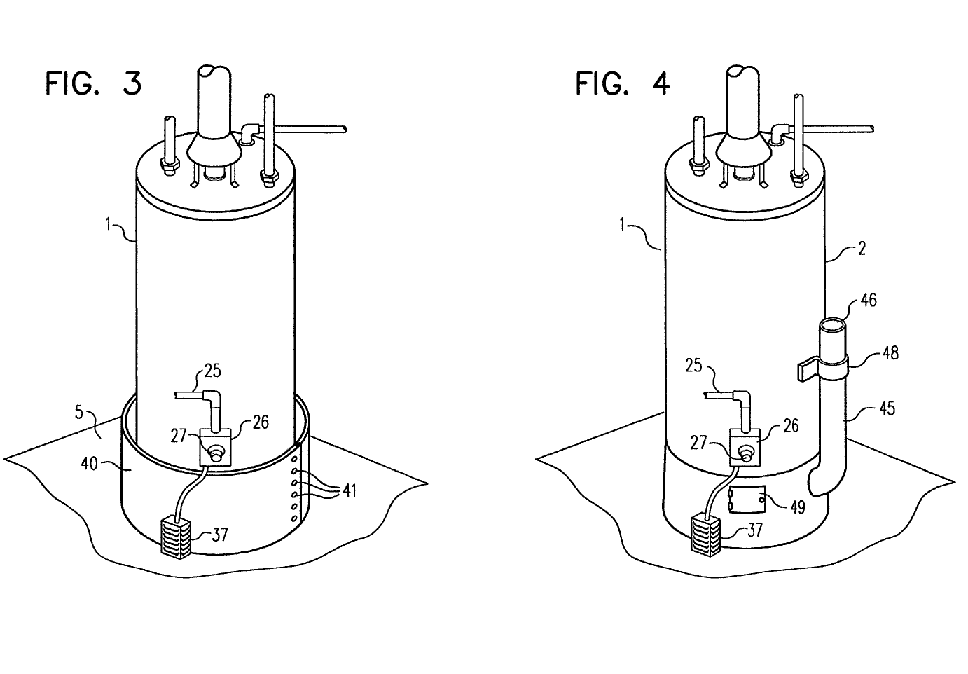

There are several alternative embodiments to effect my invention for a typical gas fed appliance such as a hot water heater or furnace. If the appliance such as a hot water heater 1 cannot be elevated from the floor as shown in FIG. 1, appliance or the hot water tank 1 could be installed within a concentric cylindrical air barrier or skirt 40 as shown in FIG. 3. The barrier 40 completely surrounds the appliance, here a hot water heater 1 placed on a floor 5 and forces combustion source of air to be withdrawn into the appliance from the height of the barrier skirt 40, effectively elevating the combustion source of air intake above the floor. While the height of the barrier skirt 40 may be as high as desired, there are practical considerations to the construction of the barrier skirt 40. A practical height for the barrier skirt 40 is 18 inches. It can be made from a rectangular piece of suitable material, cut to a width desired with a length sufficient to completely surround the base of the hot water heater 1, then ends of the rectangular piece joined with suitable attachment means 41 such as screws, rivets and the like. Here the FVD 35 within its protective casing 37 with louvered vents 38 is attached to the outside surface of the base of skirt 40 and wired to the control box 26 in the same fashion as shown in FIG. 1, described above. In this way, the barrier requires combustion source of air for the appliance to be drawn from at least the height of barrier skirt 40, operating in the same manner as if the appliance were elevated to that height while the FVD is at the floor level.

A third alternative embodiment provides for the combustion source of air intake to be brought to the combustion chamber of the appliance is by means of a snorkel 45 as shown in FIG. 4. The combustion source of air intake, shown here as a hot water heater, the combustion chamber 12 is enclosed within duck-work with an inlet snorkel 45 so that all the combustion source of air to the air chamber of the appliance, such as the hot water heater must pass through the snorkel 45 at its elevated intake 46. As with the barrier skirt 40, the snorkel may be of any length, but there are practical considerations to its installation and construction. A practical length for the snorkel is 18 inches long. The FVD 35 within its protective casing 37 with louvered vents 38 is installed at the base of the hot water heater and wired to the control box 26 in the fashion in the two examples above. Again, the barrier requires combustion source of air for the appliance be drawn from at least the height of the intake of the snorkel 46 in the same manner as if the appliance were elevated to that height. The air passages, here a water heater 30 are enclosed with a circular strip of duck-work of suitable material 47 and formed to seal off all of the air-intakes 30 (not shown in FIG. 4) except for the area of the input of the snorkel 45. For other appliances, duck-work of suitable material enclose all the sources of air for the appliance according to the size and shape of the appliance and channeled into a snorkel so that the opening of the snorkel is the only combustion air entrained into the appliance. In this example, the snorkel 45 may be attached to the outer shell 2 of the hot water heater 1 with a suitable bracket 48. An outer door 49 positioned above door 17, as shown in FIG. 1 provides access through the duckwork 47 for service of the appliance as may be necessary. In this fashion, the duckwork with snorkel require combustion source of air for the hot water heater to be drawn from at least the height of snorkel 45 operating in the same manner as if the appliance were elevated to that height while the FVD is at the floor level. While the above description contains many specifications, there should not be construed as limitations on the scope of the invention, but rather as an exemplification of preferred embodiments thereof. Accordingly, the scope of the invention should be determined not by the embodiment illustrated, but by the appended claims and their legal equivalents.

What is claimed is:

1. A gas fired appliance safety device for interrupting the source of gas to a gas fired appliance, the appliance having a valve to interrupt said gas, a source of combustion air, the device comprising:
a flammable vapor detector capable of instructing said valve to interrupt said gas whenever said detector detects flammable vapor resulting from flammable liquid on a floor.

2. A gas fired appliance safety device as claimed in 1 further comprising;
said vapor detector mounted in a location where said flammable vapor is in a higher percent concentration in air than the flammable vapor in the air at the source of combustion air, the detector responding to the presence of flammable vapor at the detector before said flammable vapor reaches a lower flammability limit at the source of combustion air to said appliance.

3. The gas fired appliance safety device as claimed in 2 where said vapor detector is mounted at an elevation closer to the floor than the source of combustion air.

4. The gas fired appliance safety device as claimed in 2 where said source of combustion air to said appliance is at an elevation higher than where the vapor detector is mounted.

5. The gas fired appliance safety device as claimed in 3 where said vapor detector is mounted at a floor.

6. The gas fired appliance safety device as claimed in 5 where the elevation of the source of combustion air is at least 18 inches from the floor.

7. A gas fired appliance safety device as claimed in 2 where said gas fired appliance is a hot water heater.

8. A gas fired appliance safety device as claimed in 2 where said gas fired appliance is a power vent water heater.

9. A gas fired appliance safety device as claimed in 2 where said gas fired appliance is a air heating furnace.

10. A water-heater safety device for interrupting fuel fed to a gas fired water heater whenever flammable vapor is present comprising:
a container for water;
a combustion chamber below elevation of said water and proximal to the container;
a source of combustion air to said chamber;
a line for fuel to flow from a source to said chamber;
said fuel igniting within the chamber to form heat for said water;
a detector capable of generating a signal in the presence of flammable vapor;
a valve in said line having a flow position to permit the flow of fuel and a no-flow position to interrupt said flow of fuel, said signal urging the valve to a no-flow position to extinguish said igniting of fuel within the chamber.

11. The water heater safety device as claimed in 10 also comprising:
a pilot flame powered by said source of fuel;
a pilot flame sensor;
first means to urge the valve to the flow position;
a second means to urge the valve to the no-flow position when ever said pilot flame is not sensed by said sensor.

12. The water heater safety device as claimed in 11 where said pilot flame sensor comprises a thermocouple positioned to respond to said pilot flame and said first means to urge is an electric current signal communicating with the valve.

13. The water heater safety device as claimed in 12 wherein said signal is a variance in electrical resistance of said detector, the detector in electrical series with said thermocouple.

14. The water heater safety device as claimed in 10 where the detector is at an elevation lower than the elevation of the source of combustion air.

15. The water heater safety device as claimed in 10 where the combustion air source is at an elevation above the elevation of the detector.

16. The water heater safety device as claimed in 10 where the hot water heater is mounted at an elevation above the elevation of the detector.

17. The water heater safety device as claimed in 10 further comprising:
a cylinder having a height, the cylinder surrounding a base of the water heater from the floor, the source of air directed from the height of the cylinder to said cylinder;
the detector mounted to an exterior of said cylinder, at the floor.

18. The water heater safety device as claimed in 10 further comprising:
a air intake barrier surrounding the source of air to said chamber at the base of said water heater;
a vertically oriented snorkel communicating through said barrier to an upwardly oriented opening;
the detector mounted at a base of an exterior of said barrier;
said snorkel directing said combustion air source through said opening at an elevation above the detector.

19. The water heater safety device as claimed in 13 where the detector is mounted at an elevation below the elevation of the combustion air source.

20. The water heater safety device as claimed in 13 where the combustion air source is at an elevation higher than the elevation of said detector.

21. The water heater safety device as claimed in 13 where the combustion air source is at an elevation at least 18 inches above the elevation of said detector.

22. The water heater safety device as claimed in 10 where the water heater is a fuel fired residential hot water heater.

23. A safety device for interrupting fuel fed to a water heater, the water heater having a container for water, a combustion chamber under and proximal to the container, a source of air to said chamber, a line to convey fuel to said chamber, said fuel igniting within the chamber to form heat for said water, a pilot light for igniting the fuel, a pilot light sensor to generate a current whenever the pilot light is lit, a valve in said line having a flow position to permit the flow of fuel and a no-flow position to interrupt said flow of fuel, a means to urge the valve to a flow position whenever said sensor generates a current above a pre-set level, a second means to urge the valve to a no-flow position when said current is below said pre-set level, the flammable safety device comprising:
a detector capable of generating a resistive response in the presence of flammable vapor;
the flammable vapor detector electrically communicating in series with said pilot light sensor, the resistive response decreasing said current below said pre-set level to urge said valve to a no-flow position.

24. The claim of 23 wherein the air to the intake of said hot water heater is raised at an elevation above the elevation of said detector.

25. The claim of 23 wherein the hot water heater is raised from a floor and said detector is mounting at the floor.

26. The claim of 23 further comprising:
an outer cylindrical air barrier encircling the base of said water heater to require said air intake at the height of said barrier and mounting said detector at an outside base of said barrier.

27. The claim of 23, further comprising:
a snorkel vertically oriented with an upper opening at an elevation above the floor;
an air intake barrier directing said air intake through said opening;
said detector mounted to an outside base of said barrier at an elevation below said opening.

28. The claim of 24 wherein the hot water heater is a fuel fired residential hot water heater.

29. A gas fired appliance safety device for interrupting the source of gas to gas fired appliance comprising:
a cut-off valve for said source of gas to said gas fired appliance;
a source of air to said appliance;
a vapor detector capable of generating a signal in the presence of flammable vapor;
said valve having a flow position to permit the flow of gas and a no-flow position to interrupt said flow of gas through said source, the signal urging the valve to a no-flow position in the event that the signal is generated.

30. The safety device as claimed in claim 29 wherein said appliance is raised at an elevation above said floor while the detector is mounted at an elevation below said source of air.

31. The safety device as claimed in claim 30 wherein said detector is mounted at the floor.

32. The safety device as claimed in claim 29 wherein said gas fired appliance is a power vented water heater.

33. The safety device as claimed in claim 29 wherein said gas fired appliance is a hot air furnace.
